(19) United States
(12) Patent Application Publication
(10) Pub. No.: US 2006/0267997 A1
(43) Pub. Date: Nov. 30, 2006

(54) Systems and methods for rendering graphics in a multi-node rendering system

(76) Inventors: Jeffrey Joel Walls, Fort Collins, CO (US); Donley Byron Hoffman, Fort Collins, CO (US); Byron Alan Alcorn, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/135,815

(22) Filed: May 24, 2005

(51) Int. Cl. G09G 5/00

(52) U.S. Cl. 345/581

(57) ABSTRACT

A system is provided for rendering three-dimensional graphics. The system comprises a host capable of executing an application program that calls for the rendering of a graphics image in an application window and a plurality of render nodes configured to cooperate to render at least a portion of the graphics image in response to graphics input supplied by the host. The system further comprises logic capable of configuring each of the plurality of render nodes to render a plurality of noncontiguous screen-space areas.

### BACKGROUND OF THE INVENTION

The rendering of computer graphics, especially three-dimensional graphics, is a computationally intensive process. In many high-end applications, computer graphics are rendered using a pool or cluster of computers, which share the processing responsibilities. In such a system, one computer may be configured to execute at least one application program and communicate graphics data to other computers for rendering. In this regard, a collection of computers may be configured to cooperatively render a graphics image and may receive the graphics data to be rendered from the computer executing the application program.

When multiple computers are used to render a single scene or image, the video signals generated by each of those computers are combined into a single aggregate (or composite) signal and encoded in a particular format, such as NTSC (National Television Standards Committee), PAL (phase alteration by line), etc. There exist devices called compositors that perform the function of combining (or compositing) multiple video signals into a single, composite video signal. Accordingly, there are known approaches for performing the functions of a compositor.

In operation, a host or master computer is configured to execute an application program, which generates, for example, three-dimensional graphics for presentation to a user. Program control, two-dimensional graphics and windows, user interface functions, and other aspects may be performed on the master or host computer. Three-dimensional graphics-rendering operations, however, are performed by a plurality (or cluster) of slave or render nodes. In such a system, a significant amount of data and other information is communicated from the host or master computer to the render nodes for rendering. As graphics scenes change, windows are moved or resized, or content within the windows is changed, additional communications occur between the host computer and the various render nodes in order to communicate changed information to the render nodes for rendering.

Reference is now made to the drawings, in which FIG. 1 illustrates a multi-node system for rendering three-dimensional graphics. Many high-end or intensive graphic programs are executed, and graphics images are rendered, using a plurality of computers in combination. There are various ways in which multiple computers are configured to operate either in parallel or in conjunction to perform a graphics-rendering task. One way is to configure one computer 110 to operate as a master (or host), and configure the remaining plurality of computers 120 to operate as slaves (or render nodes). In the illustrated embodiment, the slave computers 120 are configured to collectively render a three-dimensional graphics image. The rendering among the slave computers 120 is partitioned or allocated in a variety of ways. One way is to divide the screen space into various partitions and have each slave computer render the data associated with its partition.

In the embodiment illustrated in FIG. 1, the master computer 110 executes an application program 112 that involves the rendering of three-dimensional graphics. The control and functionality of the application program 112 is handled by the master computer 110. As well, the master computer 110 handles various two-dimensional graphics rendering that is incidental to the execution of the application program 112. For example, the presentation of drop-down menus or other items of presentation that do not require three-dimensional rendering is performed by the master computer 110. Each of the computers (master computer 110 and each of the slave computers 120) comprises a graphics card (or other graphics circuitry) that outputs a signal for a video display 140. Since, however, the content that is rendered by each of the computers must first be combined, the video outputs of each of the computers are delivered to a compositor 130. A compositor 130 operates to combine the content of each of the plurality of input video signals to deliver a single, composite output signal 132 that is used to drive a display device 140.

An alternative environment comprises multiple displays 140 that are configured to operate as a single logical display. There are a variety of applications in which graphics information is presented over a panel or matrix of displays, to effectively emulate a single, large display. Examples of such systems include: real estate, financial (such as the stock market), control room, large engineering processes, military mapping, telecommunications, etc. Such systems require the output of large amounts of data, which can easily exceed the viewable display capacity of a single, physical monitor (a user could view relevant data only by panning and zooming).

In a system environment such as that of FIG. 1, the computer 110 executing the graphics application program communicates to the cluster of render nodes 120 the relevant data utilized for carrying out the rendering operations. The structure and content of such data will be known and appreciated by persons skilled in the art, as it is the underlying data specifying primitives, texture, lighting, shading, and other aspects employed for rendering a given graphics image. In one embodiment, such information is communicated by the master 110 to the individual slave computers as appropriate, based upon the partitioned operation of the slave units.

Although multiple render nodes can improve the processing speed of graphics systems, further improvements are desired. For example, workload imbalances among the various render nodes results in inefficient processing, wherein some render nodes may be idle while others are processing data and may have even more data queued for processing.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating certain components in a system constructed in accordance with an embodiment of the invention.

FIG. 2 is a diagram illustrating a screen-space allocation of a four-node render cluster of a system constructed in accordance with an embodiment of the invention.

FIG. 3, is a diagram illustrating screen space, which corresponds to a display area, in an embodiment of the invention.

FIGS. 4A, 4B, and 4C are diagrams illustrating a screen space having differing render node allocations, in accordance with embodiments of the invention.

FIG. 5 is a diagram illustrating a view frustum operation, which is utilized in embodiments of the invention for certain computations.

FIGS. 6A and 6B are diagrams that illustrate screen space of alternative embodiments of the present invention.

FIG. 7 is a diagram illustrating certain components within a system constructed in accordance with an embodiment of the invention.

FIG. 8 is a flowchart illustrating the top-level functional operation of an embodiment of the present invention.

### DETAILED DESCRIPTION

Accordingly, there is a desire for systems and methods that provide more efficient three-dimensional graphics rendering.

It should be understood that the embodiments described herein are presented to illustrate certain concepts and features of embodiments of the invention, and the scope and spirit of the present invention should not be construed as limited to only the embodiments described. The term “window” as used herein should be construed in a generic fashion. The term “window” is not intended to be associated with or limited to a screen area that is created or presented under the Microsoft Windows operating system. Indeed, as should be appreciated from the description herein, the concepts and teachings of the present invention are applicable to windowing environments in general. Such environments could include a Microsoft Windows environment, an X (sometimes referred to as X Windows) Unix-based system, or other windowing systems.

Further, the embodiments described herein use the terms “application window” and “graphics window.” The term “application window” refers to a rectangular area that is created or defined by an application program running on a host computer. In contrast, the term “graphics window” refers to a sub-window of an application window. In this regard, an application window generally consists of a plurality of graphics windows, which plurality of windows include both two-dimensional and three-dimensional graphics windows. Indeed, in the X windowing environment, even the simplest application windows may comprise a number of graphics windows. It is common for an application window to comprise many user interface components (e.g., menus, widgets, decorations, dialogs, and so on) with only a small number of three-dimensional windows.

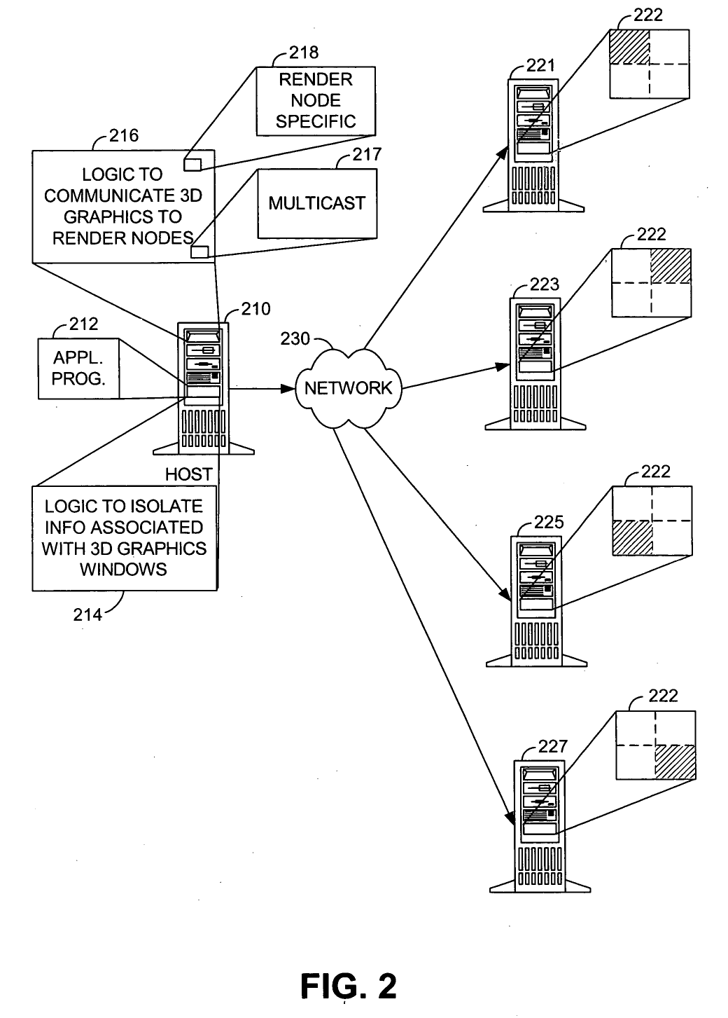

Reference is now made to FIG. 2, which is a diagram illustrating certain aspects of an embodiment of the present invention. Specifically, FIG. 2 illustrates features pertaining to the host and render nodes, and the compositor and display components have been omitted from this figure for simplicity. In the embodiment illustrated in FIG. 2, a host node 210 is configured to execute an application program 212 that calls for the rendering of three-dimensional graphics. For purposes of illustration herein, consider an application program such as a CAD (computer-aided design) modeling program, that enables a user to design, model, and/or display three-dimensional figures. In addition to the three-dimensional figures or models that may be represented on the display, such an application program also presents menus and other items to a user, which do not require three-dimensional rendering.

The embodiment illustrated in FIG. 2 utilizes four render nodes 221, 223, 225, and 227. Of course, consistent with the scope and spirit of the invention, additional or fewer render nodes may be utilized. Further, each illustrated render node is allocated or assigned a specific portion of the display 140, such that the graphics image to be rendered is subdivided in screen space and allocated to each of the respective render nodes. In the illustration provided in FIG. 2, render node 221 is allocated (indicated by shading) the upper left quadrant of the display (virtual display represented by reference number 222), render node 223 is allocated the upper right quadrant of the display, render node 225 is allocated the lower left quadrant of the display, and render node 227 is allocated the lower right quadrant of the display. Consistent with the scope and spirit of the invention, additional render nodes may be configured to carry out additional render operations, which may, for example, be applicable to the entire display. For example, one embodiment may utilize six total render nodes, wherein each of four of the render nodes is configured to individually process and render information relevant to only their respective single quadrant of the display area, while each of the remaining two render nodes are configured to process and render information relevant to the whole display area.

The host node 210 further comprises logic 214 for identifying and isolating information associated with three-dimensional graphics windows. This “information” comprises information necessary for rendering the content of the three-dimensional graphics window, as well as information defining the size and placement of the three-dimensional graphics window on the display. In addition, the host node 210 comprises logic 216 for communicating the information associated with the three-dimensional graphics windows to the render nodes. In one embodiment, the logic 216 comprises logic 218 for mapping the information onto the specific and relevant render nodes and communicating the information to only the render nodes that require the information for performing their rendering operation in the particular quadrant or portion of the display screen allocated to the respective render nodes. In another embodiment, this information may be communicated to all render nodes using, for example, a multicast messaging protocol 217.

As a brief illustration, consider the execution of the application program 212, such that it generates only one three-dimensional graphics window, and further that that three-dimensional graphics window implicates only the top central portion of the display screen. In such an embodiment, only render nodes 221 and 223 are implicated, as render nodes 225 and 227 are responsible for rendering the lower half of the display screen. Therefore, in such a scenario, after the logic 214 identifies and isolates the relevant information for rendering the three-dimensional graphics window, logic 216 communicates that information to render nodes 221 and 223 for rendering. It can be readily appreciated that such an embodiment minimizes unnecessary communications over the network 230 (e.g., no communications to render nodes 225 and 227), and further minimizes unnecessary resource consumption of the bandwidth of various render nodes by providing each render node with only the information needed for its effective operation.

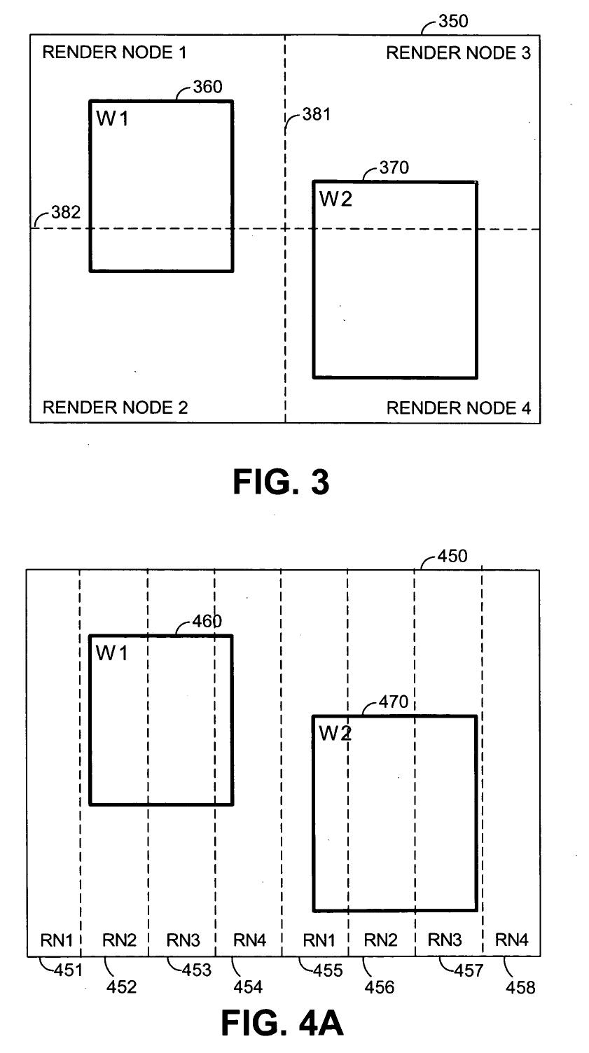

Reference is now made to FIG. 3, which illustrates screen space 350, which corresponds to a display area that is visible to a user. In the illustration of FIG. 3, the screen space 350 contains two three-dimensional graphics windows 360 and 370. In a multi-node rendering system configured as illustrated in FIG. 2 (where each render node is allocated one-fourth of the screen space), then the render nodes would render disproportionate shares of the graphics windows 360 and 370. As illustrated by the dashed lines 381 and 382, which bisect the screen space 350, it is readily observed that render node 1 and render node 4 will have to render more information than render node 2 or render node 3 (assuming a relatively equal distribution of three-dimensional graphic content within each of the graphics windows 360 and 370).

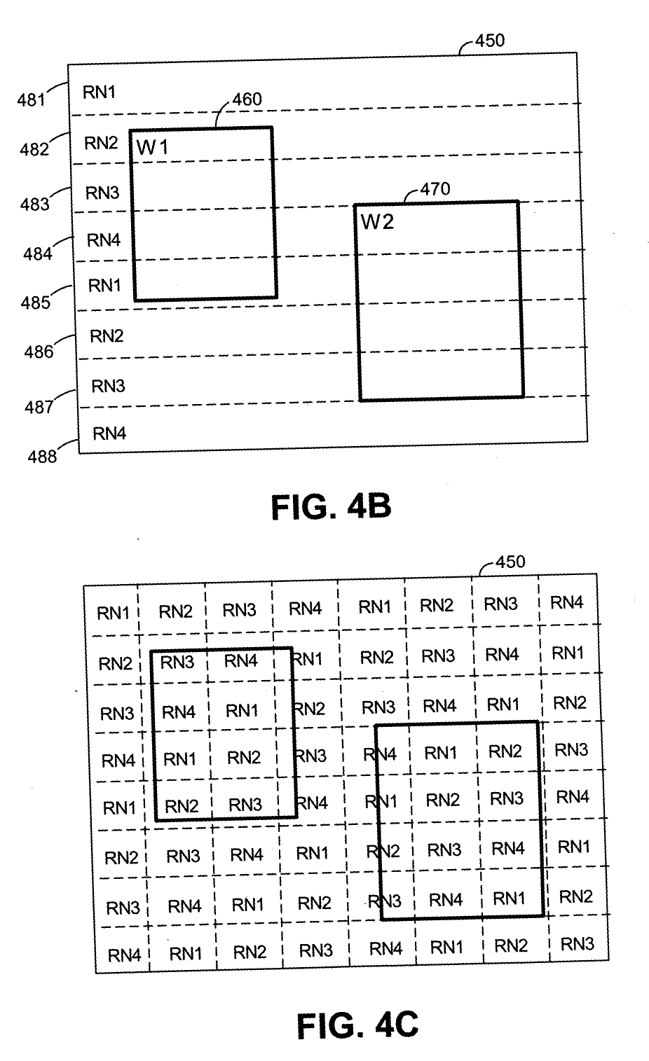

Reference is now made to FIGS. 4A, 4B, and 4C, which illustrate a screen space 450 having differing render node allocations, in accordance with various embodiments of the present invention. For example, FIG. 4A illustrates graphics windows 460 and 470 contained within a screen space 450. In the embodiment of FIG. 4A, each render node (in an embodiment having four render nodes) is allocated two separate (or noncontiguous) areas of the screen space 450 for rendering. More specifically, in the embodiment of FIG. 4A, the screen space 450 is divided into eight substantially-equal portions along vertical boundaries. That is, the screen space 450 is striped vertically to define smaller screen-space areas 451-458. The various render nodes are alternately assigned consecutive screen-space areas, such that render node 1 is assigned to screen-space areas 451 and 455, render node 2 is assigned screen-space areas 452 and 456, render node three is assigned screen-space areas 453 and 457, and render node four is assigned screen-space area 454 and 458. It will be appreciated that, in general, partitioning the screen space into smaller regions and assigning multiple, noncontiguous regions to each of the plurality of render nodes will, on average, result in a more even distribution of processing among the various render nodes.

Consistent with the scope and spirit of the invention, the screen space 450 of FIG. 4A could have also been divided into five, ten, sixteen, thirty-two, sixty-four, or some other number of vertically-oriented screen space areas. Some embodiments may divide the screen into regions that are a power of two (e.g., four, eight, sixteen, thirty-two, etc.), other embodiment may utilize an alternative number of screen space areas. As noted above, as the screen space is divided into more areas, a more even distribution of processing can be achieved among the render nodes. However, additional partitions result in additional overhead and management (which will be described further herein). Therefore, the specific number of partitions of the screen space 450 may vary depending upon the application and goals of the particular graphics system of a given implementation.

Reference is now made to FIG. 4B, which shows an implementation similar to that illustrated in FIG. 4A, except that the screen space 450 is partitioned into a plurality of horizontally-disposed screen space regions 481-488. Again, and as described in connection with FIG. 4A, each render node is assigned a plurality of noncontiguous screen-space areas for rendering. Providing multiple screen-space areas to each render node results in a statistically more even distribution of rendering among the various render nodes.

Reference is made briefly to FIG. 4C, which illustrates yet another embodiment of the invention, wherein the screen space 450 is partitioned into a plurality of grids (or rectangles) both vertically and horizontally disposed. In the illustrated embodiment, the screen space 450 is divided into sixty-four rectangular areas, with a plurality of those sixty-four rectangular areas being assigned to each of the render nodes in the system. As in the previous illustrations, the illustration of FIG. 4C assumes four render nodes are utilized to collectively render the three-dimensional graphics. Consistent with the scope and spirit of the invention, fewer or additional render nodes may instead be utilized.

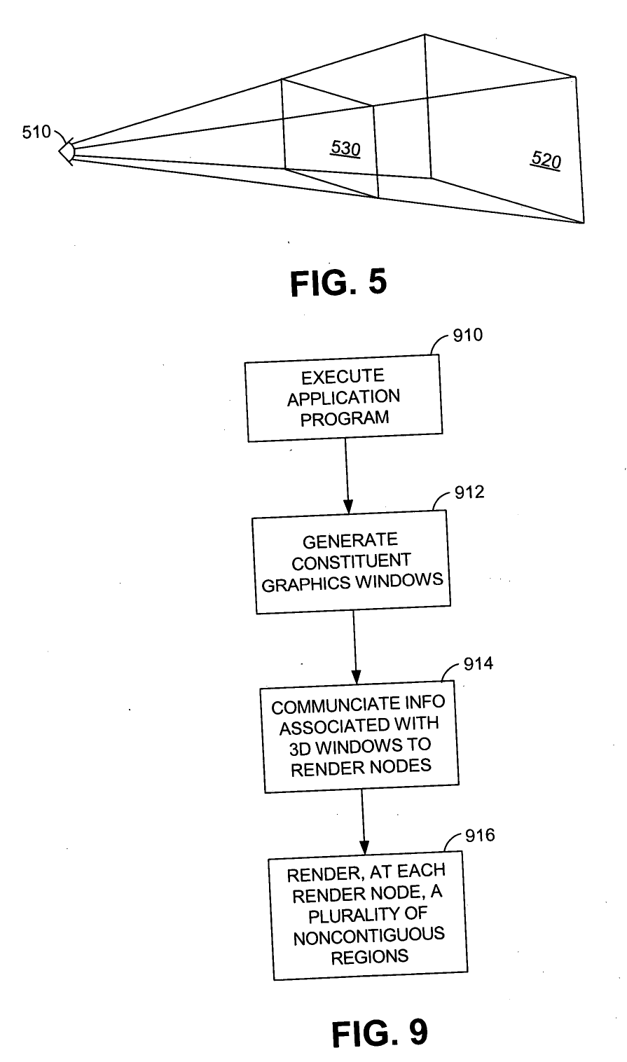

In the illustrations of FIGS. 4A, 4B, and 4C, the screen space 450 has been illustrated as being partitioned into a plurality of rectangular regions. In the embodiment of FIG. 4A, each of the rectangular regions spanned the entire vertical dimension of the screen space 450. In the embodiment of FIG. 4B, each of the partitions spanned the entire horizontal dimension of the screen space 450. In the embodiment of FIG. 4C, each of the rectangular screen-space partitions comprised only a portion of the horizontal and vertical dimensions of the screen space 450. It will be appreciated that, consistent with the scope and spirit of the invention, other, non-rectangular shapes may be accommodated for the various screen-space partitions. In the embodiments described herein, and as will be further explained in connection with FIG. 5, rectangular-shaped screen-space partitions can be readily implemented using a view frustum operation, which is supported in openGL or through similar concepts of other graphics APIs (Application Program Interfaces).

Reference is now made to FIG. 5, which is a diagram illustrating the view frustum operation mentioned above. As is known, the processing of three-dimensional graphics involves the rendering and display of three-dimensional objects on a two-dimensional display screen. This general process is well known and documented. The diagram of FIG. 5 illustrates a concept that is frequently utilized in this process. This “view frustum” operation, as it is sometimes referred to, includes the culling (or elimination) of objects that are outside of a field of view. With regard to the diagram illustrated in FIG. 5, a viewpoint 510 is illustrated to reflect a relative position of a user's eye (or the viewpoint for the information to be displayed on the screen). As is known, the field of view from this viewpoint extends outwardly in the space between the eye and the display screen (or far plane 520). All objects comprising the graphics scene falling outside of this area are not visible to the user on the display screen, and therefore may be culled to minimize processing time.

In addition, the view frustum operation also includes the implementation of a near-end plane, 530, which is parallel to the far-end plane 520, and the region defined between the far end plane 520, near-end plane 530, and the four polygon-shaped sides that extend between the near-end plane 530 and far-end plane 520 define what is sometimes referred to as a “bounding box.” In accordance with the view frustum operation, all objects that fall within the bounding box are rendered, while all objects outside of the bounding box are culled.

In embodiments of the present invention, the view frustum operation is applied to the various screen-space partitions such as those illustrated in FIGS. 4A-4C. Consider, for example, the embodiment illustrated in FIG. 4C. In one embodiment, the host node defines sixty-four distinct bounding volumes, having far-end display areas that correspond to the screen-space partitions illustrated in FIG. 4C, and communicates the relevant information for each of those bounding volumes to the assigned or corresponding render nodes. The render nodes then process the corresponding graphics information to generate their respective portions of the rendered display, which are communicated to, and combined by, the compositor to generate a single composite signal for an image to be displayed on a display.

The edges of the view frustum can be thought of as “clip planes”. On the horizontal and vertical striping embodiments described herein, a set of clip planes can be created for each strip. The bounding volumes of the primitives being tested are compared against these clip planes. The graphics card performs the remaining view-frustum tests. For example, in an embodiment having vertical striping, a left/right clip plane is defined for each rendering region. The bounding volumes of the primitive are compared against these clip planes before the data is sent to the graphics device driver. If the bounding volume is found to be within any of the render regions, the primitives within the bounding volume are sent to the graphics driver. The graphics driver and graphics card are responsible for performing the remaining frustum culling (in this case the upper, lower, front and back).

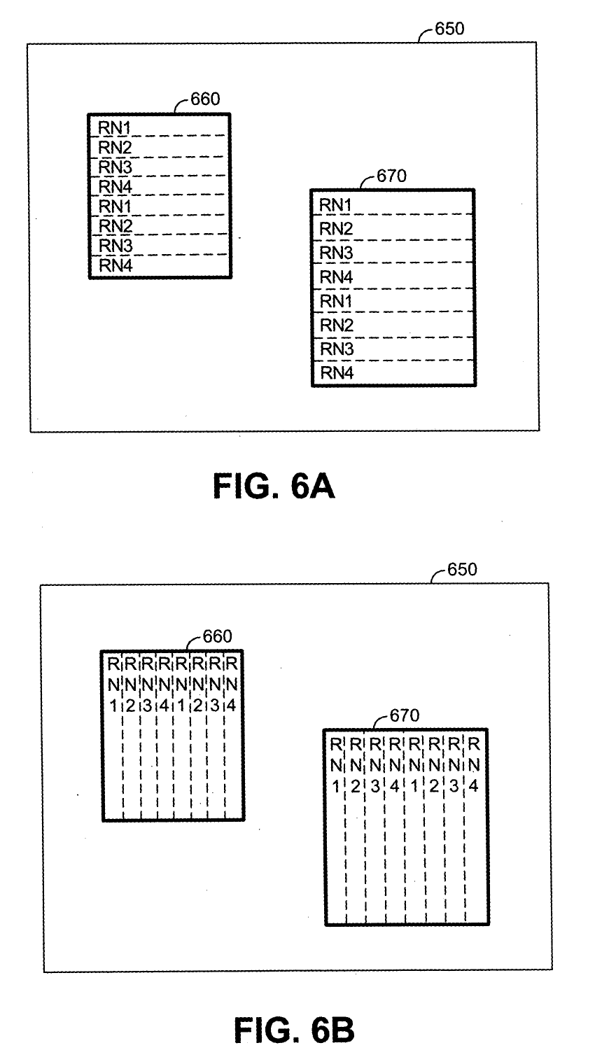

Reference is now made briefly to FIGS. 6A and 6B, which illustrate alternative embodiments of the present invention. The previous embodiments have illustrated predefined regions of the display that have been correspondingly associated with the screen-space render operations for each render node. That is, each of the plurality of render nodes, in the previously-described embodiments, is assigned a plurality of pre-defined screen-space regions for processing, and these pre-defined screen-space regions do not change over time. In the embodiments illustrated in FIGS. 6A and 6B, the partitioning and allocation is implemented on a per-window basis, rather than on a display basis. The concepts described above in connection with FIGS. 4A-4C, regarding the horizontal, vertical, or grid-like allocation of the areas to be rendered among the various render nodes can be similarly applied in the context of render node allocation in a per-window basis (rather than display basis). For example, graphics windows 660 and 670 could be partitioned into, for example, eight horizontally-oriented regions or eight vertically-oriented regions as shown in FIGS. 6A and 6B, respectively. Similarly, the windows could be partitioned into rectangular-shaped regions, as the display area of FIG. 4C was partitioned. Further still, the embodiment of FIG. 6A and 6B could be implemented using fewer than eight or more than eight partitions per window.

It will be appreciated, in such an embodiment, the dynamic allocation for the various render nodes will be communicated from the host node to the compositor, so that the compositor can configure its internal logic to appropriately construct the composite image from the plurality of signals that are received from the various render nodes. It will be further appreciated that, although the embodiments illustrated in FIGS. 4A-4C and 6A-6B depict a relatively even distribution of screen space among the plurality of render nodes, that other embodiments may have unequal distributions of screen space among the plurality of render nodes.

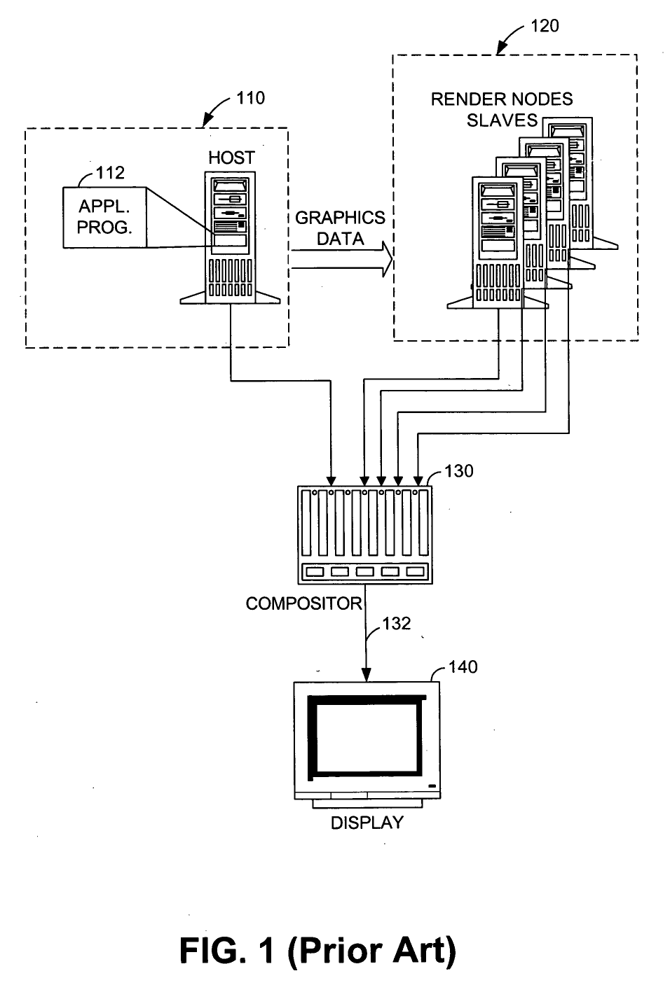

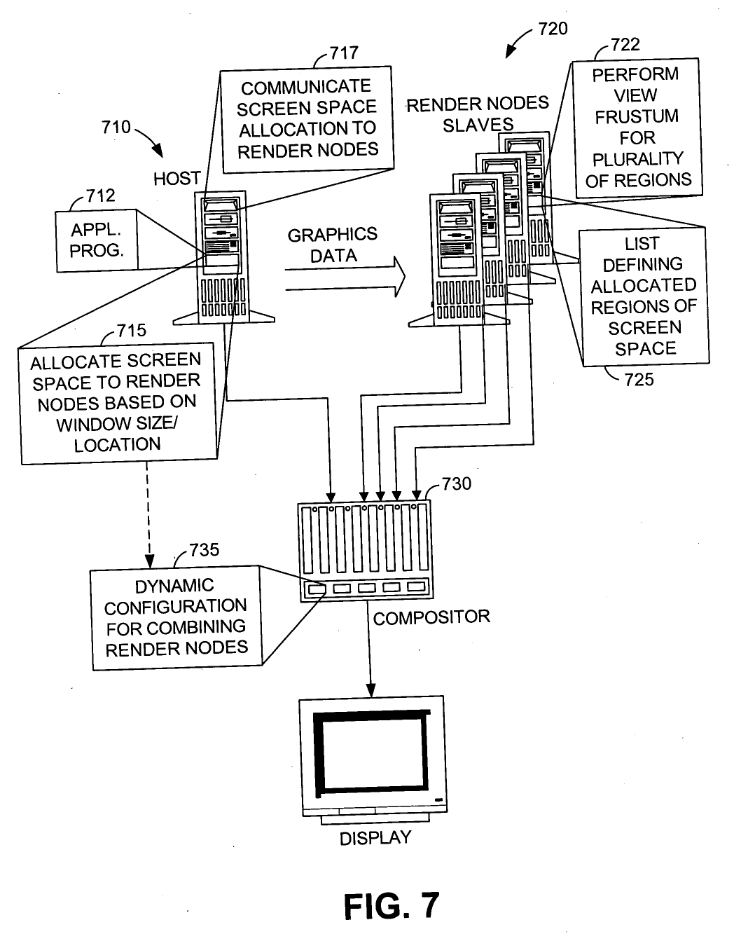

In this regard, reference is made to FIG. 7, which is a diagram illustrating certain components within a system constructed in accordance with an embodiment of the invention. The system comprises a host node 710 and a plurality of render nodes 720. As described in connection with FIG. 1, the host node 710 is configured to be capable of executing an application program 712 that calls for the display of at least one three-dimensional graphics context graphics. A compositor 730 operates to combine the signals carried on the outputs of the plurality of render nodes 720 to generate a single, composite signal for delivery to a display. In this regard, the compositor comprises logic 735 that configures the compositor 730 for proper operation, based upon the screen space that is allocated to each of the plurality of render nodes. In implementation of embodiments such as those illustrated in FIGS. 4A-4C herein, this logic 735 is pre-configured on the compositor 730 and remains static (in that it does not change as the host 710 carries out the execution of an application program 712). In, however, embodiments such as those illustrated in FIGS. 6A and 6B, in which the screen space allocated to the various render nodes dynamically varies as graphics windows are created and/or reconfigured (e.g., resized or moved), then the logic 735 is dynamically configured to correspondingly combine the output from the plurality of render nodes 720 so that an appropriate composite signal is produced. In such an embodiment, the host 710 comprises logic 715 that is capable of allocating screen space to the various plurality of render nodes, based upon the size and location of graphics windows as created and/or reconfigured by the application program 712. The host node 710 further comprises logic 717 for communicating such a dynamically-determined screen space allocation to the render nodes 720 and the compositor 730.

With regard to the render nodes 720, each render node 720 comprises logic 722 for performing a view frustum operation (as described above) for a plurality of screen-space regions that have been assigned to the render node. In short, based upon information communicated to the render node 720 by the host node 710, which information defines both graphics content as well as size and location of the graphics window(s), the render node 720 can perform the rendering operations that are relevant to the intersecting portions of the graphics windows and screen space that has been allocated to the particular render node. Each render node further comprises logic 725 that contains or defines a list of regions or areas that has been assigned to that render node for processing. This list is static in certain embodiments, such as those illustrated in connection with FIGS. 4A-4C. In alternative implementations, this list or other information is dynamically modified based upon the reallocation of screen space, as determined by the host node 710 (for embodiments such as those illustrated in FIGS. 6A and 6B).

In operation, each render node performs rendering operations on the intersection(s) of the screen space areas defined by logic 725 and the three-dimensional graphics window(s) currently being processed. In one embodiment, the compositor 730 is configured to receive outputs from the host 710 and each of the plurality of render nodes 720. The compositor 730 configured to generate a composite output signal for a display.

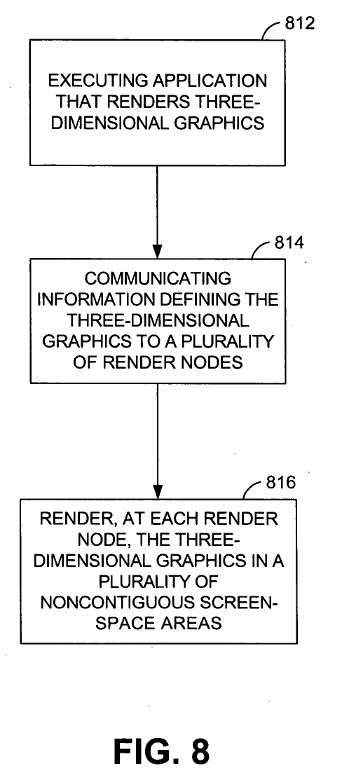

Reference is made to FIG. 8, which is a flow chart illustrating the top-level operation of an embodiment of the invention. In accordance with one embodiment, a method executes, on a host node, an application program 810 that calls for the rendering of at least one three-dimensional graphics in an application window. The method also communicates 814, from the host node to a plurality of render nodes, information for defining the three-dimensional graphics. In addition, the method renders 816, at each of the plurality of render nodes, the three-dimensional graphics communicated from the host in a plurality of noncontiguous screen-space areas. With regard to the manner in which the method identifies and communicates three-dimensional graphics information to the plurality of render nodes, embodiments of approaches are disclosed in co-pending patent application Ser. No. 11/048,192, filed on Feb. 1, 2005 and co-pending patent application Ser. No. 11/051,688, filed on Feb. 4, 2005.

Finally, reference is made to FIG. 9, which is a flow chart illustrating the top-level operation of an embodiment of the invention. In accordance with one embodiment, the method executes an application program 910 that calls for the rendering of three-dimensional graphics in an application window. The method generates constituent windows 912 (e.g., sub-windows of the application window), such that at least one render node is assigned the responsibility of rendering graphics for at least two non-contiguous constituent windows. The method also communicates 914, from the host node to a plurality of render nodes, information for defining the three-dimensional graphics. In addition, the method renders 916, at each of the plurality of render nodes, the three-dimensional graphics communicated from the host in a plurality of noncontiguous screen-space areas.

What is claimed is:

1. A system for rendering graphics comprising:
a host capable of executing an application program that calls for the rendering of at least one graphics image in an application window;
a plurality of render nodes configured to cooperate to render at least a portion of the at least one graphics image in response to graphics input supplied by the host;
logic capable of configuring each of the plurality of render nodes to render a plurality of noncontiguous screen-space areas.

2. The system of claim 1, wherein the host is capable of executing an application program that calls for the rendering of at least one three-dimensional graphics image.

3. The system of claim 1, wherein each of the plurality of noncontiguous screen-space areas comprise an area that corresponds to an area that extends horizontally across an entire display.

4. The system of claim 1, wherein each of the plurality of noncontiguous screen-space areas comprise an area that corresponds to an area that extends vertically down an entire display.

5. The system of claim 1, wherein the plurality of noncontiguous screen-space areas comprise a plurality of rectangular areas.

6. The system of claim 1, wherein logic is further capable of configuring each of the plurality of render nodes to render each of the plurality of noncontiguous screen-space areas using a view frustum operation.

7. The system of claim 6, wherein the logic is configured to implement the view frustum operation using OpenGL.

8. The system of claim 6, further comprising area-defining logic associated with each of the plurality of render nodes, the area-defining logic configuring each of the plurality of render nodes to evaluate a plurality of defined areas to determine the presence of three-dimensional graphics within the defined area, and to further execute the view frustum operation for each area determined to have three-dimensional graphics.

9. The system of claim 1, further comprising a compositor configured to generate a composite signal from a plurality of signal output from the plurality of render nodes.

10. In a graphics rendering system, a method comprising:
executing, on a host node, an application program that calls for the rendering of at least one graphics image in an application window;
communicating, from the host node to a plurality of render nodes, information for defining at least a portion of the graphics image; and
rendering, at each of the plurality of render nodes, the graphics communicated from the host in a plurality of noncontiguous screen-space areas.

11. The method of claim 10, wherein the executing comprises executing an application that calls for the rendering of at least one three-dimensional graphics image.

12. The method of claim 10, wherein the rendering further comprises performing a view frustum operation for each of the noncontiguous screen-space areas.

13. The method of claim 10, further comprising evaluating a plurality of defined areas to determine the presence of three-dimensional graphics within the defined area.

14. The method of claim 13, further comprising performing a view frustum operation for each area determined to have three-dimensional graphics.

15. The method of claim 10, further comprising combining the plurality of noncontiguous rendered areas at each render node and outputting a digital signal containing the combined rendered areas.

16. The method of claim 15, further comprising combining the digital signal output from each of the plurality of render nodes to generate a single composite signal.

17. A system for rendering graphics comprising:
means for executing an application program that calls for the rendering of at least one graphics image in an application window;
means for rendering at least a portion of the graphics image in response to graphics input supplied by the means for executing; and
means for configuring each of a plurality of separate portions of the means for rendering to render a plurality of noncontiguous screen-space areas.

18. The system of claim 17, means for executing more specifically comprises means for executing an application program that calls for the rendering of at least one three-dimensional graphics image.

19. The system of claim 17, wherein each of the plurality of noncontiguous screen-space areas comprise an area that corresponds to an area that extends horizontally across an entire display.

20. The system of claim 17, wherein each of the plurality of noncontiguous screen-space areas comprises an area that corresponds to an area that extends vertically down an entire display.

21. The system of claim 17, wherein means for configuring is further capable of configuring each of the plurality of render nodes to render each of the plurality of noncontiguous screen-space areas using a view frustum operation.
